(19) United States
(12) Patent Application Publication
(10) Pub. No.: US 2003/0144964 A1
(43) Pub. Date: Jul. 31, 2003

(54) Method and device for securing data for sending over an open network

(76) Inventor: Jan P.C. Spevart van Woerden, Rotterdam (NL)

Correspondence Address: Mark Zovko, 36504 28th Avenue South, Federal Way, WA, 98003, US

(21) Appl. No.: 10/203,670

(22) PCT Filed: Feb. 9, 2001
(86) PCT No.: PCT/NL01/00108

(30) Foreign Application Priority Data
Feb. 9, 2000 (NL) 1014328

(51) Int. Cl. G06F 17/60

(52) U.S. Cl. 705/64

(57) ABSTRACT

The invention relates to a method for securing data for sending over an open network, comprising at least one of the new measures as stated in the above description, in addition to a device for secured transmission of data over an open network, comprising at least a first computer and a second computer connectable thereto via the network, wherein these computers are programmed such that they can perform the above stated method.

The developments in the field of computer networks and Client-Server architecture have resulted in electronic commerce (E-Commerce) experiencing a very strong growth. This growth has also been made possible by the very open network architecture which are employed in many networks (particularly the Internet).

A consequence of this open architecture is however that these networks are very difficult to secure.

In the eyes of many there are therefore still too many risks involved in the use of the Internet as infrastructure for carrying out transactions, which in the case of a successful attempt at fraud would result in the loss of large sums. Only payment orders and credit-card authorizations are therefore given over the Internet for sums in the order of magnitude of consumer purchases.

It would however be a relief for financial institutions as well as the financial departments of large companies if transactions over the Internet could be completely secured.

In security technique the following security functions are distinguished:

“Confidentiality”=unauthorized persons cannot access the content of exchanged messages,

“Integrity”=parties can be certain that a message has not been changed in transit,

“Authenticity”=the recipient can ascertain with certainty from whom a message originates.

“NRO”=the sender cannot deny having signed a message. (NRO stands for Non-Repudiation of Origin).

For network's such as the Internet there exist many protocols which are very satisfactory in particular respects. The per se known TLS protocol (an improvement of SSL) for instance can provide excellent “Confidentiality” over a connection. If one of the parties has a certificate of a CA (=Certification Authority, =party which provides a key of a Web site with a “certificate of authenticity”), then the other party can be confident about whom he or she has contact with, provided at least that he trusts the CA. This can work both ways, although in practice HTTP Servers have certificates, and Clients to a much lesser degree. A decision could be taken to send credit card details over such an Internet connection because it is no longer possible to eavesdrop this data.

This situation is comparable with a secured voice tube:

1) No one can eavesdrop the voice tube (confidentiality)

2) It is known who is on the other side of the tube during conversation (authenticity), if the party on the other side has a certificate.

Transmission of data in a database arranged behind a Web server, by means of a browser, can thus take also place over a secured line.

However, these protocols operate at the transport layer of the OSI layer model, and not at the presentation layer of this same model.

The OSI layer model has 7 layers, within each layer a particular protocol is employed to make the services provided by this layer available to higher layers. These layers are:

the application layer, here is defined how applications interact.

the presentation layer, here is defined the format in which applications send information to each other, for instance in “HTML” or in “Word format”

the session layer, here is defined how a communication session is brought about, for instance the HTTP protocol.

the transport layer, here is defined how data is transmitted, for instance according to the TC protocol. SSL is implemented on this layer.

the network layer, here is defined how computers can find each other, for instance by means of the IP protocol.

the data link layer, here is defined how the bits and the bytes are ordered.

the physical layer, here is defined how the link operates physically: voltages, sizes of plugs, etc.

This has the result that cryptographic security of the data ceases as soon as this data has left “the secured voice tube” and is stored in the memory of the HTTP server. The data is then no longer protected by any cryptographic technique at all. Protection must then take place by shielding the access to the server. In the case of a machine which has the purpose of allowing a great many users to log on via the Internet, this is extremely cumbersome.

Nor is data protected when it is redirected to a background system for further processing. Even if this connection is in turn transmitted further by means of encryption techniques, the background application at for instance a bank has no way of determining whether a transaction has been added to the system in a valid way by a client or in invalid manner by a system manager.

In order to obviate these drawbacks so-called end-to-end security is applied. In the field this is understood to mean the possibility of securing data, wherever it may be located during processing thereof, at all times by means of cryptographic techniques. This is achieved by securing the data at the presentation level. Provided cryptographic techniques of sufficient strength are applied, the data can then not be modified while in transit, not even if it is located temporarily on an insecure machine. It is assumed here that the application which will process the data at the end of the route will only process the data after having checked the validity of the security attributes. When correctly implemented, this solution is by far the best from a security viewpoint.

So as to enable end-to-end security the data and the security attributes must be sent to the end application in a form which can be processed by the end application. (MRD=Machine Readable Data). Known formats in the exchange of financial data are SWIFT (MT 100 series), EDIFACT (payord, payext, paymul). In addition, every country has developed its own formats for the purpose of clearing.

These formats can be read extremely well by machines, but hardly or not at all by people, and certainly not by the normal users of financial software. The data must moreover comply very precisely with the exchange standard, rectifying a “small error” at the receiving end just to enable processing of the data is no longer possible because the security attribute thereby becomes immediately invalid.

The data must therefore be edited by an application which can correctly apply the message standards to be used and which can show the data via an interface to the person authorized to decide whether he/she will add the security attribute to the MRD.

A transaction-specific application is required for this purpose. In the client-server model such a transaction-specific client is also designated as “fat client”, because a part of the application logic is incorporated in this client.

An example of making a security attribute in such a classical model is as follows:

The variables have the following meaning:

MRD = Machine Readable Data
HRD = Human Readable Data
SHA = example of a hash function
RSA = example of a seal function
SSK = Sender's Secret Key
SPK = Sender's Public Key
RSK = Recipient's Secret Key
RPK = Recipient's Public Key
HASH = result of the SHA function
SEAL = result of the RSA function
BCF = Basalt Contract Function

| | |
|---|---|
| At the sender | |
| Input data | Use the fat client to make MRD locally. |
| Approve data | Show the MRD via an interface to the |
| | signer. |
| Calculate | HASH = SHA (MRD) |
| Hash | |
| Calculate | SEAL = RSA (HASH, SSK) |
| Seal | |
| Send | send MRD + SEAL to the server. |
| At the recipient (server): | |
| Receive | receive MRD + SEAL from the client. |
| Calculate | HASH1 = SHA (MRD) |
| Hash1 | |
| Calculate | HASH2 = RSA (SEAL, SPK) |
| Hash2 | |
| Compare: | if HASH1 = HASH2, then recipient can |
| | determine that SEAL = RSA (HASH, SSK) is |
| | “true”, without the recipient having to |
| | know SSK for this purpose. |

A condition for the security of the above scheme is that the function SHA is so-called “Collision Resistant” and that the SSK and the SPK form a unique key pair.

Collision resistance means that, if a HASH 1 has been derived from an MRD1 file via SHA, it must not be possible to find an MRD2 from which HASH1 could be derived once again via SHA, since if this were the case, then both MRDs would have the same electronic signature (i.e.: RSA (HASH1).

It is also a condition that SSK and SPK form a unique key pair, so that the recipient, when validating with SPK, knows for certain that the signer has used SSK.

Up to this point, the classical model.

It is noted that the used functions SHA and RSA are examples. The application of the invention is in no way limited to a particular algorithm.

The invention is also applicable if a so-called MAC function is used to generate security attributes. (A function which generates a Message Authentication Code), where for instance a SEAL is calculated directly from MRD:

SEAL=MAC(MRD, SYMMETRICALKEY).

A drawback of the “fat client” model is that in the case of changes to the application logic or the MRD formats, the installed client applications have to be replaced by new ones.

This drawback does not occur in the case of the model of HTTP servers and Web browsers used on the Internet. With one and the same browser, which needs only little application logic, it is possible to communicate with very many different Servers. The application-specific logic is located on (or behind) the HTTP server.

Changes can hereby be made in the application logic (server side) without the browser (client side) having to be adapted, which greatly simplifies maintenance for the application manager.

This applies in fact to all systems which are built on a thin client architecture, and not only to HTTP servers and Web browsers.

A thin client cannot however generate any server-specific security attributes (at least not without becoming a fat client).

A thin client can however secure the transport layer (which looks the same for all applications), but end-to-end security is then no longer possible.

According to the invention the process outlined above, wherein a security attribute is calculated at the fat client in two steps (a SHA1 function and an RSA function), is replaced by the process following hereinbelow, which involves HRD (Human Readable Data) in addition to MRD (Machine Readable Data).

| | |
|---|---|
| At the sender: (client) | |
| Input data | = Use a thin client to create MRD at the |
| | Server |
| At the recipient: (server) | |
| Produce Con- | HRD = BCF (MRD) |
| tract | |
| Send | Send HRD to sender. This can be done online, |
| | for instance via HTTP, or offline, for |
| | instance via SMTP. |
| At the sender: (client) | |
| Approve data | = Show the HRD directly to the signer |
| Calculate | HASH = SHA (HRD) |
| Hash | |
| Calculate | SEAL = RSA (Hash, SSK) |
| Seal | |
| Send | = send SEAL to the server |
| At the recipient (server): | |
| Receive | = receive SEAL from the thin client. |
| Calculate | SHA1 = SHA (HRD) |
| Hash1 | |
| Calculate | SHA2 = RSA (SEAL, SPK) |
| Hash2 | |
| Compare: | if HASH1 = HASH2 then |
| | SEAL = RSA (Hash, SSK) is “true”. |

If the data and the security attribute are sent on to an application which does not operate on the server but which will process the data, this third application must act as follows:

At the recipient, (downstream application):

| | |
|---|---|
| Make Contract | HRD = BCF (MRD) |
| Calculate | SHA1 = SHA (HRD) |
| Hash1 | |
| Calculate | SHA2 = SHA (SEAL) |
| Hash2 | |
| Compare: | if HASH1 = HASH2 then |
| | SEAL = RSA (Hash, SSK) is “true”. |

A condition is that BCF is “Collision resistant”, just as SHA must be in the classical case (and now also). If this is the case, this means that the chain from MRD to SEAL is “closed”: it is possible to conclude by means of SPK that SEAL is made from HASH using SSK, and also to conclude that HASH is made from HRD by means of SHA, and finally to conclude that HRD is made from MRD, therefore: it is safe to process MRD, because the associated HRD has been signed correctly by the client.

How this BCF is formatted depends on the application, the only condition is that it is collision resistant.

An example in pseudo-code is as follows:

MRD: +123;456;789+(3 fields, separated by the “;” character)

BCF: Transfer from my account <field1> an amount to the sum of <field2> to account number <field3>.

HRD=BCF (MRD)=Transfer from my account 123 an amount to the sum of 456 to account number 789.

BCF must further comply with the condition that the HRD produced by BCF can be shown to the signer by a generic security client. It is here that the method according to the invention differs from the classical method: to be able to present the data to the signer according to the classical method an application is required which can interpret the specific MRD (fat client).

The invention is not limited to the use of bash functions or functions with symmetrical keys. It is also possible to calculate a SEAL from HRD by means of a MAC function or any other suitable function which results in a security attribute.

Nor is the invention limited to any specific format of the HRD, this may be text, pixel, data, vector data or other format.

The method according to the invention has the following advantages:

End-to-end Encryption. Because the function BCF is unambiguous and collision resistant, just as the function SHA, the last machine in the chain can validate end-to-end encryption.

Thin signature client. The contract consists of HRD, i.e. this data can be shown by a generic and simple representation on a display at the client machine, which may therefore be a “thin contract signer client”, in contrast to the fat clients which are required for processing and signing MRD.

The client can in fact be so thin that, in addition to implementation in PCs, he may also be implemented on mobile telephones or in smartcards, or other very small or inexpensive equipment, wherein only very summary displays need be used for showing the HRD. Even a smart card reader equipped with a small LCD panel could thus show the HRD to the owner of the card.

(Multiple) Remote Signing. It often occurs that bulk data is produced by a computer which cannot be reached physically or logically by a person authorized for signing. Because the recipient party can present the HRD for signing to a person authorized to sign via a separate channel (for instance the Internet), this person can place his electronic signature from anywhere in the world. This can also be done by 2 or 3 different people at separate locations.

What You See Is What You Sign. (WYSIWYS). In the case of a fat client an MRD is signed which cannot really be read by a person. In WYSIWYS one signs what one sees. Compare:

| | |
|---|---|
| MRD: | BGM:12345++67890+13579′5500000+12+78906+35791′ |

With:

| | |
|---|---|
| to the credit of | to the debit of |

| HRD: | amount | account no. | account no. | Reference |
|---|---|---|---|---|
| | 123.45 | 67-890 | 13-579 | |
| | 5,500.00 | 78-906 | 35-791 | 12 |

Data can be converted. As long as BCF is collision resistant, the technical representation of the MRD can change without the validity of the electronic signature thereby being affected under the HRD. Also after a change of the representation a computer can calculate the HRD from the MRD, the HASH1 from the HRD, the HASH2 from the SEAL and SPK, and it can compare HASH1 and HASH2 with one another.

Flexibility in the representation of the HRD. For a single transaction the HRD can be presented as an easily readable sentence. (See the example in the description of the BCF). If there are many transactions, HRD can exist in table form (see example above) and for a large quantity of data it is possible to grant authorization on the basis of statistical data, see example below:

I hereby agree to the execution of tape no. 654.A.3 with the following attributes:

| | |
|---|---|
| transactions | 15,457 |
| total amount | 75,456,451.45 |
| total sum of the last 3 | 6,878,547 |
| digits of account numbers | |
| largest amount on the tape | 12,784.63 |
| highest total amount | 13,452.32 |
| credited to the same account | |

When there is a change in the BCF function (MRD>HRD) the security client does not have to be modified. The security client is capable of showing and having signed any syntactically correct HRD.

The Basalt security servers and security clients have the option of administering the used BCF functions.

1. Method for securing data for sending over an open network, comprising at least one of the new measures as stated in the above description.

2. Device for secured transmission of data over an open network, comprising at least a first computer and a second computer connectable thereto via the network, wherein these computers are programmed such that they can perform a method as claimed in claim 1.
